(19) United States
(12) Patent Application Publication
(10) Pub. No.: US 2026/0245180 A1
(43) Pub. Date: Aug. 20, 2026

(54) Method and System for Subject-Driven Image Synthesis with Noise Consistency Regularization

(71) Applicant: Mitsubishi Electric Research Laboratories, Inc., Cambridge, MA (US)

(72) Inventors: Yao Ni, Canbera (AU); Anoop Cherian, Acton, MA (US); Song Wen, New Brunswick, NJ (US)

(73) Assignee: Mitsubishi Electric Research Laboratories, Inc., Cambridge, MA (US)

(21) Appl. No.: 19/053,723

(22) Filed: Feb. 14, 2025

(51) Int. Cl. G06T 5/60; G06T 5/70; G06T 7/00; G06T 11/00

(52) U.S. Cl. CPC G06T 5/60; G06T 5/70; G06T 7/0004; G06T 11/00; G06T 2207/20081; G06T 2207/30164

(57) ABSTRACT

A computer-implemented method for adapting a pre-trained diffusion-based generative model to synthesize subject-specific images is disclosed. The method involves obtaining a pre-trained diffusion model, a set of subject images representing the unique characteristics of the target subject, and a set of prior images generated by the pre-trained model. The pre-trained model is fine-tuned by optimizing a first loss function designed to predict diffusion noise for the subject images during a reverse diffusion process, ensuring the preservation of the subject's identity. Additionally, a noise consistency regularization technique is employed to optimize a second loss function, which minimizes the discrepancy between the diffusion noise predictions of the pre-trained and fine-tuned models for the prior images. The resulting fine-tuned diffusion model is capable of generating subject-specific images while maintaining the generalization capabilities of the original pre-trained model, making it suitable for diverse applications in image synthesis.

### TECHNICAL FIELD

The present disclosure relates to the field of artificial intelligence, specifically to generative models for image synthesis. More particularly, the present disclosure pertains to methods and systems for fine-tuning diffusion-based models to achieve subject-driven image synthesis with enhanced identity preservation and output diversity.

### BACKGROUND

Generative diffusion models operate by transforming structured data into random noise and then reconstructing it through a learned reverse process. This mechanism, known as diffusion noise, serves as the foundation for creating diverse and high-fidelity outputs. The forward diffusion process gradually corrupts an image, such as a statue, by adding Gaussian noise until it becomes indistinguishable from randomness. The reverse process, central to diffusion models, involves predicting and removing this noise step by step to either reconstruct the original image or generate new samples.

The ability of diffusion models to generate diverse outputs stems from the randomness inherent in the initial noise. Each unique noise pattern corresponds to a distinct generative path, allowing the model to create a wide range of outputs while preserving the statistical patterns learned during training. For example, a single model is configured to generate both classical marble statues and modern sculptures by leveraging variations in the input noise. Despite this versatility, fine-tuning such models for subject-driven synthesis, where specific subjects must be preserved across diverse contexts, poses significant challenges.

Existing solutions attempt to fine-tune diffusion models for subject-specific synthesis by incorporating synthetic images. These images, generated based on broad class descriptions (e.g., “a photo of a dog”), are used to reinforce the model's pre-trained knowledge while adapting it to the subject. However, these approaches have two major drawbacks. First, they rely heavily on the quality, diversity, and relevance of the synthetic images, which typically introduce biases and inconsistencies. Second, they emphasize reproducing generated images rather than addressing the core mechanism of diffusion models: the prediction and removal of noise. As a result, these methods often fail to fully preserve subject identity and generate sufficiently diverse outputs simultaneously.

### SUMMARY

It is an object of some embodiments to disclose a system and a method for subject-driven image synthesis by focusing on noise consistency during the fine-tuning of diffusion models. Additionally, or alternatively, it is an object of some embodiments to addresses the shortcomings of prior art by optimizing the prediction and removal of diffusion noise, thereby achieving a balance between subject identity preservation and image diversity.

To that end, some embodiments employ noise consistency for prior images. The fine-tuned model is trained to predict noise for prior (non-subject) images in a manner consistent with the pre-trained model. This alignment prevents catastrophic forgetting, ensuring that the fine-tuned model retains general knowledge from the pre-training phase.

Additionally, at least some embodiments employ multiplicative noise consistency for subject images. To improve diversity, these embodiments introduce multiplicative Gaussian noise to the latent representations of subject images. The model is then trained to predict consistent noise for both the original and perturbed representations. This step expands the latent representation space, enabling the generation of diverse images while faithfully preserving the subject's identity.

The embodiments described herein offer significant advantages over existing methods in the field of subject-driven image synthesis. A key benefit is the enhanced ability of the model to reliably capture and reproduce the unique features of a subject with exceptional fidelity. By focusing on the underlying mechanisms of noise prediction and removal, the model preserves the subject's identity with greater accuracy compared to prior approaches.

Additionally, the incorporation of an optional multiplicative noise consistency feature greatly improves the diversity of generated outputs. By expanding the latent representation space through the application of noise, the model is able to create a broader range of image variations while maintaining the integrity of the subject's defining characteristics. This balance between identity preservation and creative diversity marks a notable improvement in the field.

Finally, the focus on noise consistency for prior images ensures the model retains its generalization capabilities. This means that, in addition to subject-specific synthesis, the model continues to perform effectively when generating non-subject images, maintaining the versatility and robustness essential for practical applications. Together, these advancements establish a comprehensive framework that outperforms existing methods in fidelity, diversity, and adaptability.

The proposed solution is adaptable and efficient, allowing users to balance training speed and creative flexibility based on specific requirements. By reducing reliance on synthetic images, the method simplifies implementation and ensures consistent performance across various applications, including personalized content generation, advertising, and creative tools.

Accordingly, one embodiment discloses a computer-implemented method for fine-tuning a pre-trained diffusion-based generative model to synthesize subject-specific images. The method includes obtaining a pre-trained diffusion model, a set of subject images, and a set of prior images generated by the pre-trained diffusion model. The method further includes fine-tuning the pre-trained diffusion model by optimizing a first loss function (Ls) configured to predict diffusion noise for the subject images during a reverse diffusion process to preserve an identity of a subject in the subject images subject to a noise consistency regularization that optimizes a second loss function (Lcp) to minimize a discrepancy between prediction of the diffusion noise of the pre-trained and fine-tuned diffusion models for the prior images. The method also includes outputting a fine-tuned diffusion model configured to generate subject-specific images while retaining generalization capabilities of the pre-trained diffusion model.

Another embodiment discloses a system for fine-tuning a diffusion-based generative model to synthesize subject-specific images. The system comprises a memory for storing instructions, and a processor configured to execute the instructions to obtain a pre-trained diffusion model, a set of subject images and a set of prior images. The processor is also configured to execute the instructions to fine-tune the pre-trained diffusion model by optimizing a first loss function Ls to predict diffusion noise for the subject images during reverse diffusion, and preserving a subject's identity. The processor is also configured to execute the instructions to fine-tune the pre-trained diffusion model by optimizing a second loss function Lcp to enforce consistency between the noise predictions of the pre-trained and fine-tuned diffusion models for the prior images. Furthermore, the processor is also configured to execute the instructions to fine-tune the pre-trained diffusion model by optimizing a third loss function Les to enforce consistency between noise predictions for original and perturbed latent representations of the subject images. The processor is further configured to execute the instructions to output a fine-tuned diffusion model configured to generate subject-specific images with improved fidelity and diversity.

Yet another embodiment discloses a non-transitory computer-readable storage medium embodied thereon a program executable by a processor for performing a method for fine-tuning a pre-trained diffusion-based generative model to synthesize subject-specific images. The method includes obtaining a pre-trained diffusion model, a set of subject images, and a set of prior images generated by the pre-trained diffusion model. The method further includes fine-tuning the pre-trained diffusion model by optimizing a first loss function (Ls) configured to predict diffusion noise for the subject images during a reverse diffusion process to preserve an identity of a subject in the subject images subject to a noise consistency regularization that optimizes a second loss function (Lcp) to minimize a discrepancy between prediction of the diffusion noise of the pre-trained and fine-tuned diffusion models for the prior images. Moreover, the method includes outputting a fine-tuned diffusion model configured to generate subject-specific images while retaining generalization capabilities of the pre-trained diffusion model.

### BRIEF DESCRIPTION OF THE DRAWINGS

FIG. 1 shows a schematic of a system, according to some embodiments, that operates in one or both of two distinct stages—training and inference—each optimized to achieve personalized image synthesis with enhanced fidelity and diversity.

FIG. 2 shows a schematic of a computer-implemented method, according to some embodiments, that focuses on fine-tuning a pre-trained diffusion-based generative model to generate subject-specific images while ensuring that the model retains its generalization capabilities.

FIG. 3 shows a schematic of a method for computing a second loss function (Lcp), according to some embodiments, to achieve noise consistency regularization.

FIG. 4 shows a flowchart of a method for improving diversity in the generated subject-specific images according to one embodiment.

FIG. 5 shows a schematic of generating and applying the Gaussian noise according to one embodiment.

FIG. 6 shows a block diagram of a method configured to enhance diversity and fidelity in subject-driven image synthesis using fine-tuned diffusion models according to some embodiments.

FIG. 7 shows a schematic of computing device that is representative of any system or collection of systems in which the various processes, programs, services, and scenarios of some embodiments disclosed herein are implemented.

### DETAILED DESCRIPTION

### Overview of the Contribution to the Art

This overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

In the world of generative diffusion models, the process of creating a random statue- or any data from scratch-begins with a concept known as diffusion noise. Diffusion noise refers to the random disturbances added to data during a process called the forward diffusion process. This deliberate corruption of data serves as the foundation for the model's ability to generate new samples. Imagine starting with a clear and detailed image of a statue; during the forward process, noise is added step by step, gradually obscuring the image until it becomes indistinguishable from pure randomness. The reverse process, which is the essence of a diffusion model, involves carefully predicting and removing this noise to reconstruct the data or create entirely new samples.

During training, the diffusion model learns both sides of this noisy transformation. The diffusion model, at first, learns to add noise in a controlled way, simulating how data degrades over time. This noise is typically Gaussian, meaning the noise follows a predictable distribution, which allows the model to understand the patterns of corruption. Simultaneously, the model trains on the reverse process-removing this noise step by step. By predicting the specific noise added at each stage and removing it, the diffusion model reconstructs the original data. Through this process, the model learns not just the data itself but the intricate relationships between clean data and its noisy versions, giving the diffusion model the tools to work backward from pure noise.

When generating a new sample, the model starts with pure diffusion noise, which is simply a random array of values drawn from a Gaussian distribution. This noise represents the chaotic, unformed starting point, much like an artist beginning with a blank slate or a raw, unshaped block of marble. The model then applies the learned reverse process, gradually removing the noise it predicts at each step. This iterative process transforms the random input into a structured and coherent output, such as a new statue that has never been seen before. The ability to predict and remove noise accurately is critical as even small inaccuracies, typically, lead to artifacts or distortions, but precise noise removal ensures the final output is both realistic and high-quality.

The randomness of the initial diffusion noise makes diffusion models so versatile and creative. Because each random noise array is unique, it sets the model on a different path through the reverse process, resulting in diverse outputs. For example, one initial noise pattern might guide the model to create a classical marble statue, while another might lead to a sleek, modern sculpture. This diversity arises not from memorizing specific examples but from the model's understanding of the statistical patterns and structures that are learned during training.

Ultimately, diffusion noise is both the challenge and the creative spark in diffusion models. The diffusion noise provides the randomness that drives diversity while allowing the model to hone the skills in reconstruction and generation. By mastering the prediction and removal of noise, diffusion models sculpt coherence out of chaos, transforming formless noise into high-fidelity samples that align with the patterns of real-world data. This elegant interplay between noise and structure underpins the remarkable generative capabilities of diffusion models.

In the realm of subject-driven image synthesis, fine-tuning models, for example, Stable Diffusions, to generate images of specific subjects presents a delicate challenge: balancing the preservation of the subject's unique identity with the diversity of the generated images. While the subject's defining features are retained, the generated outputs should also exhibit variety in contexts, poses, and styles. Achieving this balance is particularly challenging when working with limited data for the subject, often leading to issues like underfitting or overfitting.

Some embodiments are based on recognition that some methods, such as, DreamBooth, attempt to tackle this challenge by relying on generated images. Specifically, these methods first use the pre-trained model to generate additional images based on a broad class description (e.g., “a photo of a dog”). These synthetic images are then integrated into the fine-tuning process to reinforce the pre-trained model's knowledge while adapting the pre-trained model to the specific subject. This approach aims to mitigate catastrophic forgetting, where the fine-tuned model loses its ability to generalize. However, this solution introduces limitations.

Reliance on generated images introduces two significant challenges in subject-driven image synthesis. First, the quality, relevance, and diversity of these generated images play a crucial role in the fine-tuning process. Any biases, inconsistencies, or limitations in these generated images directly impact the model's performance, often resulting in suboptimal outcomes. The dependency on generated data means that the effectiveness of the method is inherently constrained by the quality of this input, leaving room for errors and distortions.

Second, these methods tend to misalign their focus by emphasizing the preservation of generalization through image reproduction rather than addressing the core functionality of diffusion models—the prediction and removal of noise. By prioritizing the replication of generated images, the process overlooks the fundamental mechanism that drives diffusion-based synthesis. This misdirected focus hampers the model's ability to accurately capture the subject's identity while generating diverse outputs.

As a result, while the above mentioned methods provide some safeguard against catastrophic forgetting, the methods often fail to strike the delicate balance between preserving the unique identity of the subject and ensuring sufficient diversity in the synthesized outputs. This limitation underscores the need for a more targeted approach that directly addresses the underlying mechanisms of diffusion models.

Some embodiments are based on realizing that in diffusion models, the key to generating high-quality, diverse images lies in the accurate prediction and removal of diffusion noise—not in reproducing generated images. Diffusion noise governs the transformation of random latent noise into coherent images. By focusing on noise consistency, the training process directly optimizes the core mechanism that drives both subject identity preservation and image diversity. This realization shifted the emphasis away from relying on generated images and toward leveraging noise prediction as the foundation of the solution.

In addition, different embodiments use different types of fine-tuning, such as, direct fine-tuning and LoRA based fine-tuning of the models. Although both the trainings have some differences but both approaches share similarities benefiting from diffusion noise-based tuning. Some embodiments use LoRA based fine-tuning as more efficient option.

In direct fine-tuning, the parameters of the stable diffusion model are updated during the training. In LoRA based fine-tuning, the stable diffusion model is extended with a new set of parameters that are trained for keeping the original parameters of the pre-trained model frozen. The embodiments use the diffusion noise-based losses to minimize the interference of LoRA weights on the original pre-trained weights so that the LoRA weights capture the properties of the subject images, while the original diffusion weights bring in the prior knowledge.

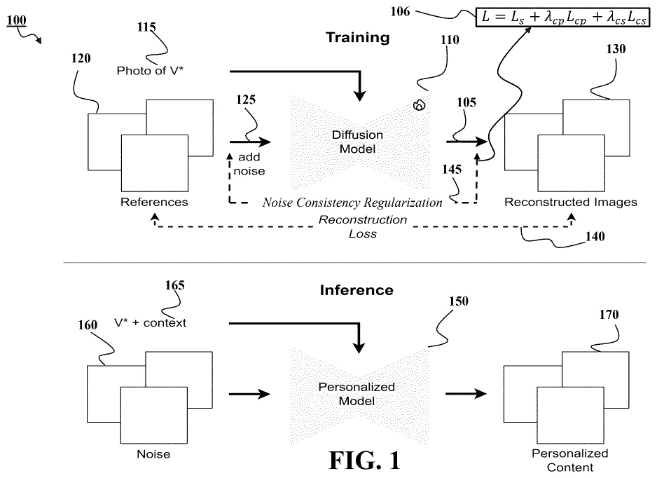

FIG. 1 shows a schematic of a system 100 according to some embodiments that operates in one or both of two distinct stages—training and inference—each optimized to achieve personalized image synthesis with enhanced fidelity and diversity.

During the training stage, the process begins with a pretrained diffusion model 110 or simply referred to as diffusion model 110, which serves as the foundation for fine-tuning. The goal is to adapt the model 110 to generate personalized content based on a specific set of input images 120 while retaining its ability to generalize across a broader range of content.

To initiate training, the system 100 may incorporate prompts 115 that specify the class or context of the input images 120. During this stage, noise 125 is deliberately added to the input images 120 to simulate the forward diffusion process. The model 110 is then tasked with reconstructing the images 120 by removing the noise, producing reconstructed images 130. This reconstruction process is governed by a reconstruction loss (140), ensuring that the output images 130 closely align with the original input images 120.

In addition to reconstruction loss, the embodiments introduce a noise consistency regularization loss 145. This mechanism ensures that the model maintains consistency in noise predictions of the diffusion noise 105 for prior (non-subject) images, aligning the fine-tuned model's predictions with those of the pretrained model. This approach mitigates catastrophic forgetting, allowing the model to retain its generalization capabilities while adapting to the new subject-specific content. The combined use of reconstruction loss and noise consistency regularization expands the model's ability to both preserve the unique identity of the subject and generate diverse, high-fidelity outputs.

Once fine-tuning is complete, the system 100 transitions to the inference stage, where the fine-tuned diffusion model 150 generates personalized images. In this stage, the model/personalized model 150 starts with a noise input 160 and a user-provided prompt 165 that specifies the desired personalized content. The fine-tuned model 150 processes this noise and prompt to generate high-quality, personalized images 170 that remain consistent with the content and characteristics of the input images 120 used during training.

Building on this understanding, the embodiments fine-tune diffusion models by integrating a noise consistency regularization framework that addresses both prior and subject-specific images. This approach uses one or two components designed to balance generalization retention and subject identity preservation.

The first component introduces the noise consistency for prior images. Here, the fine-tuned model 150 is trained to predict noise for prior (non-subject) images in a manner consistent with the predictions made by the pre-trained model 110. This alignment ensures that the fine-tuned model 150 retains the general knowledge it acquired during pre-training, thereby mitigating the risk of catastrophic forgetting. By anchoring the fine-tuned model's 150 noise predictions to the pre-trained model 110, the process minimizes overfitting to the subject-specific data, ensuring that the model remains versatile in generating non-subject images.

The second component optionally introduces multiplicative noise consistency for subject images to enhance diversity. For subject-specific images, the fine-tuned model applies multiplicative Gaussian noise to the latent representations, creating variations in the latent space. The fine-tuned model 150 is then trained to predict consistent noise for both the original and perturbed representations. This optional term, represented by the loss Lcs, expands the latent representation space for the subject, enabling the generation of diverse images while ensuring that the subject's identity is faithfully preserved.

The combined training objective (106) becomes:

$$L = {L}_{s} + {λ}_{cp} {L}_{cp} + {λ}_{cs} {L}_{cs} \qquad ( 1 )$$

where L_{cp} enforces noise consistency for prior images, Lₛ ensures subject fidelity, and L_{cs} (optional) improves diversity.

This solution provides a range of technical advantages that sets it apart from prior methods. Foremost, it improves the ability of the fine-tuned model to preserve and reproduce the unique features of a subject with high fidelity. By focusing on noise consistency during fine-tuning, the fine-tuned model captures the subject's identity more accurately than traditional approaches. Additionally, the inclusion of multiplicative noise consistency offers an optional mechanism to enhance diversity. By expanding the latent representation space, this feature allows the fine-tuned model to generate a broader range of image variations, ensuring creative and versatile outputs. Furthermore, the solution ensures generalization retention by maintaining noise consistency for prior images, enabling the fine-tuned model to continue synthesizing high-quality non-subject images alongside subject-specific outputs.

From a business perspective, this approach is both flexible and efficient. The optional diversity enhancement feature allows users to tailor the process to their specific needs, choosing between faster training or more creative flexibility. The reduced reliance on synthetic images simplifies the fine-tuning process, making it easier to implement and more consistent in performance. These attributes make the method particularly appealing for a variety of applications, including personalized content generation, and creative tools, where both precision and adaptability are highly valued.

For example, the disclosed embodiments have transformative potential for factory automation, enabling smarter and more efficient operations. One key application is in visual inspection and quality control, where the embodiments enhance accuracy by generating diverse representations of components. By simulating various operational conditions or potential defects, manufacturers, in some embodiments, train AI systems to detect issues with greater precision and reliability. The ability to incorporate variations while maintaining the unique characteristics of each component ensures robust quality control processes, reducing errors and minimizing downtime.

In robotics and machine vision, the disclosed embodiments support greater adaptability and versatility. By generating realistic and diverse synthetic images of tools, components, and factory environments, they equip robots with the ability to recognize and manipulate objects across a wide range of scenarios. This capability allows robots to seamlessly adapt to dynamic production lines or modular factory setups without extensive reprogramming. With fine-tuned models that retain subject-specific details, robotics systems operate with improved accuracy and flexibility, enhancing their overall performance.

The embodiments also accelerate product prototyping and design. Engineers, in embodiments, quickly generate diverse visual prototypes of machinery or components, allowing them to evaluate multiple configurations and refine designs more efficiently. This capability is particularly valuable in customizing factory setups, ensuring compatibility and optimizing workflows. Additionally, the ability to create clear and detailed visualizations of factory layouts or processes helps stakeholders make informed decisions during the planning and implementation phases.

Predictive maintenance benefits greatly from these embodiments as well. By generating imagery of machinery operating under various conditions, from normal functionality to early signs of wear, the embodiments strengthen the predictive power of maintenance systems. Identifying potential issues early helps manufacturers prevent unplanned downtime and prolong the lifespan of equipment. The ability to simulate rare failure scenarios further enhances operational resilience, providing peace of mind and ensuring smoother production.

Finally, the disclosed embodiments enrich training and simulation environments by creating realistic virtual factory models. These models, complete with high-fidelity images of machinery, workflows, and production lines, offer immersive and effective training for operators. Digital twins, powered by this technology, enable factories to simulate complex workflows, optimize processes, and plan improvements with greater confidence. The combination of realistic training and predictive simulations ensures that factory personnel and systems are well-prepared to handle diverse scenarios.

With their ability to enhance quality control, enable adaptable robotics, streamline prototyping, support proactive maintenance, and create immersive training environments, the disclosed embodiments deliver value to factory automation. They empower manufacturers to achieve greater efficiency, flexibility, and reliability, paving the way for more innovative and resilient industrial operations.

### Exemplar Embodiments

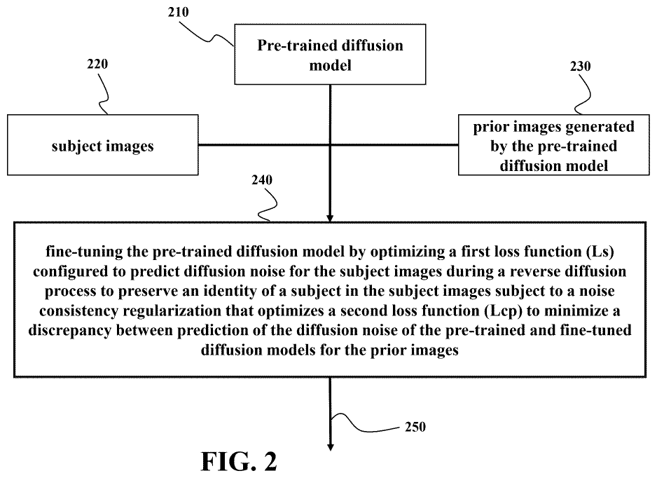

FIG. 2 shows a schematic of a computer-implemented method according to embodiments that focuses on fine-tuning a pre-trained diffusion-based generative model to generate subject-specific images while ensuring that the fine-tuned model retains its generalization capabilities. This approach introduces innovative loss functions and regularization techniques to address challenges in identity preservation and output diversity.

The disclosed method presents an approach for fine-tuning a pre-trained diffusion-based generative model to synthesize subject-specific images with the fidelity and diversity. By incorporating the disclosed training mechanisms, this method ensures the preservation of subject identity while retaining the fine-tuned model's generalization capabilities. The process/method unfolds in three key stages: obtaining the necessary components, fine-tuning the pre-trained diffusion based generative model, and generating subject-specific outputs.

At the core of this method lies a step 210 at which the pre-trained diffusion model is obtained. The pre-trained diffusion model has been trained on large-scale datasets using a diffusion process, wherein noise is progressively added to data during a forward process and removed during a reverse process. This training enables the pre-trained diffusion model to learn intricate relationships between noisy and clean representations of data. The pre-trained model serves as the foundation for fine-tuning, providing general knowledge and versatile image synthesis capabilities.

The method also includes a step 220 at which a set of subject images is obtained. The set of subject images define the unique characteristics of the specific subject to be synthesized. The subject images represent the core content that the fine-tuned model adapt to and replicate. Alongside the set of subject images, the method, at step 230, includes obtaining a set of prior images. The set of prior images are generated by the pre-trained model. The prior images act as a reference to retain the generalization capabilities of the pre-trained model, ensuring that the method does not overfit exclusively to the subject images during fine-tuning.

The method also includes a step 240 that includes fine-tuning the pre-trained model begins by teaching the pre-trained diffusion model to reconstruct the subject images during the reverse diffusion process. This involves predicting and removing noise from the subject images, with the goal of reconstructing clean outputs that are faithful to the subject. The system/method employs a first loss function (Ls) to optimize this process, focusing on minimizing the discrepancy between the reconstructed images and the original subject images. This ensures that the unique features of the subject are captured with high fidelity.

However, fidelity to the subject alone is not sufficient. To ensure that the fine-tuned model retains its generalization capabilities, the fine-tuning process incorporates a noise consistency regularization loss (Lcp). This mechanism minimizes discrepancies between the noise predictions of the pre-trained model and the fine-tuned model 250 at least for the prior images. By aligning the noise predictions across the two models, the system/method prevents catastrophic forgetting, thereby preserving the versatility of the original pre-trained model.

Upon completing the fine-tuning process, the system/method outputs a fine-tuned diffusion model 250. This model is optimized to generate subject-specific images that accurately capture the unique identity of the subject. At the same time, the fine-tuned model 250 remains capable of generating non-subject images with the same high quality and diversity as the original pre-trained model.

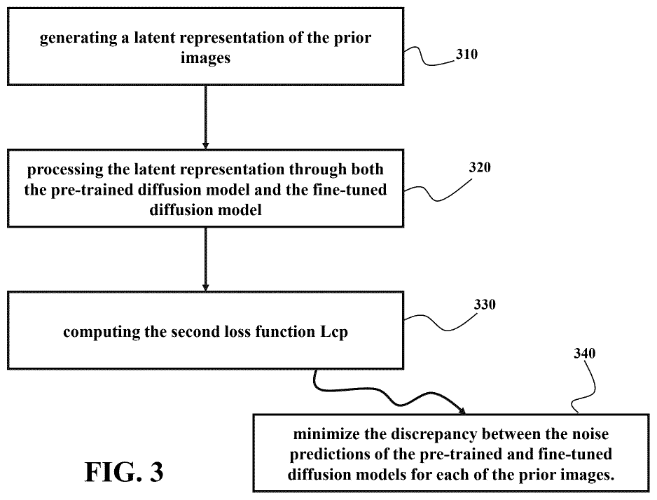

FIG. 3 shows a schematic of a method for computing the second loss function (Lcp) according to some embodiments to achieve noise consistency regularization. The computation of the second loss function begins with generating latent representations of the prior images, at step 310 of the method. These prior images are selected based on their relevance to the subject images and are derived from the pre-trained diffusion model. By converting prior images into their latent representations, the method captures their high-level features in a compressed form. This step is advantageous because it provides a common ground for comparing the outputs of the pre-trained and fine-tuned models.

Once the latent representations are generated, the prior images are processed through both the pre-trained diffusion model and the fine-tuned diffusion model, at step 320 of the method. The pre-trained model serves as the benchmark, reflecting its original knowledge before adaptation to subject-specific images. In parallel, the fine-tuned model processes the same latent representations, producing its version of the noise predictions after being trained on subject images. This dual processing allows for a direct comparison of the two models' behavior.

The core of the process lies in computing the second loss function that is performed at step 330 of the method. At the step 330, the method/system evaluates the discrepancy between the noise predictions of the pre-trained model and the fine-tuned model for each prior image. This discrepancy is quantified using a loss metric, such as mean squared error (MSE), which measures how closely the fine-tuned model aligns with the noise predictions of the pre-trained model. The smaller the discrepancy, the more effectively the fine-tuned model retains the generalization capabilities of its predecessor.

To ensure this alignment, the method, at step 340, focuses on minimizing the computed loss. During fine-tuning, the second loss function is integrated into the overall training objective, guiding the fine-tuned model to adjust its parameters in a way that reduces the divergence from the pre-trained model. This process ensures that the fine-tuned model remains versatile, capable of generating high-quality outputs across a wide range of scenarios.

In some implementations, the selection of prior images plays a crucial role in this process. The method specifies that prior images is to be chosen from a class similar to the subject images. This ensures that the pre-trained model's general knowledge within the domain of the subject images is preserved. For instance, if the subject images depict a specific type of flower, the prior images might include other flowers with varying characteristics. By maintaining this similarity, the method reduces the risk of introducing inconsistencies and ensures that the noise predictions for prior images align effectively between the two models.

Selecting prior images from a similar class also enhances the diversity of the fine-tuned model. These prior images provide variations that encourage the model to retain its ability to generate outputs beyond the specific subject while still reflecting the broader category's characteristics. However, some embodiments are based on understanding that the diversity of the images generated by fine-tuned model can be improved even further.

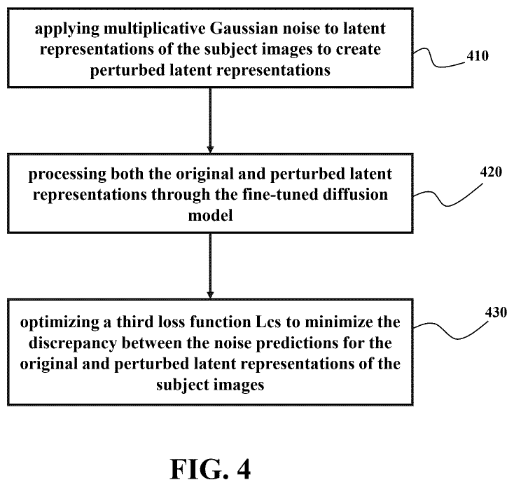

FIG. 4 shows a flowchart of a method for improving diversity in the generated subject-specific images according to one embodiment. This method is configured to enhance the diversity of outputs while maintaining fidelity to the subject's defining characteristics. By integrating controlled perturbations and leveraging consistency training, the embodiment aims to expand the range of variations the fine-tuned model generates in a structured and meaningful way.

The method at step 410 includes generating latent representations of the subject images, which encode the key features of the subject in a compact format that the fine-tuned model is configured to interpret. In some implementations, to introduce natural and beneficial variability, multiplicative Gaussian noise is applied to these latent representations. This technique proportionally scales the features of the latent representations, simulating realistic variations such as changes in perspective, lighting, or texture. These perturbations provide the model with a broader understanding of how the subject appears in different contexts.

Thereafter, at step 420 of the method, both the original latent representations and the perturbed latent representations are processed through the fine-tuned diffusion model. By handling both types of inputs simultaneously, the fine-tuned model learns to identify and align the consistent features of the subject across these variations. This step enhances the fine-tunes model's ability to generalize and adapt the subject's unique identity to diverse outputs while respecting its core characteristics.

To guide this process, the method, at step 430, employs/optimizes a third loss function (Lcs) to minimize the discrepancy between the noise predictions for the original and perturbed representations. The alignment achieved through this optimization ensures that the perturbations are incorporated as valid and complementary variations of the subject, rather than deviations. This approach benefits the fine-tuned model by expanding its latent representation space for the subject, thereby increasing the diversity of possible outputs without compromising fidelity.

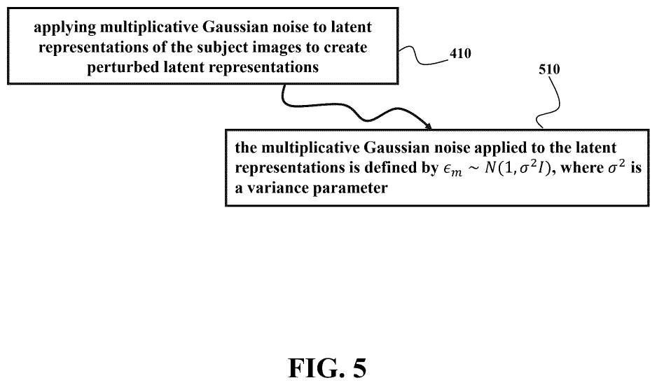

FIG. 5 shows a schematic of generating and applying the Gaussian noise according to one embodiment. In this embodiment, the multiplicative Gaussian noise applied to the latent representations at step 410 is defined by ϵₘ~N(1,σ²I), where σ² is a variance parameter, shown at step 510. This embodiment offers several benefits. The application of multiplicative Gaussian noise introduces realistic variability into the latent space, providing a foundation for creating diverse and contextually appropriate outputs. The consistency-focused training ensures that the subject's unique features are preserved, even as the model generates outputs across a broader range of styles, poses, or scenarios. By maintaining this balance, the method enriches the quality and adaptability of the generated subject-specific images.

In effect, this method provides a structured framework for enhancing diversity in subject-specific image generation. The application of noise and consistency training not only benefits the model's ability to produce varied outputs but also ensures that these outputs remain faithful to the subject's identity. This embodiment is well-suited for applications requiring creative flexibility, such as personalized content generation, artistic exploration, or adaptive visual tools among others.

### Exemplar Implementations

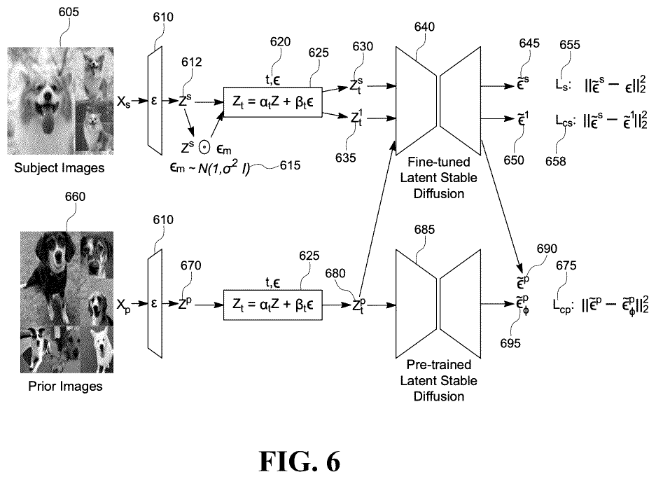

FIG. 6 shows a block diagram of a method configured to enhance diversity and fidelity in subject-driven image synthesis using fine-tuned diffusion models according to some embodiments. This approach combines advanced consistency regularization techniques and controlled perturbations to ensure the model retains the subject's identity while generating diverse and contextually meaningful outputs.

The method applies two forms of consistency regularization: one over subject images 605 and one over prior images 660. For the encodings 610 of the subject images 605, the embodiments first modulate the latent code 612 with multiplicative noise 615. Then, at the same step, the embodiments add ground truth noise 620 and identical diffusion noise 625 to both the clean and noise-modulated latent codes, yielding noisy modulations 630 and 635, which are fed into the fine-tuned stable diffusion model 640. This model has two objectives: (1) generate the diffusion (fidelity) noise 645 that approximates the ground truth noise 620, which is the basis for the first loss term 655, and (2) generate the noise 650 consistent with the perturbations 615, which is the basis for the third loss function 658.

For prior images 660, the embodiments diffuse the latent encodings 670 of the prior images 660 using the encoder 610 and input the diffused latent code 680 into both the fine-tuned latent stable diffusion 640 and pre-trained latent stable diffusion 685, enforcing consistency between the fine-tuned model's prediction 690 and the pre-trained model's prediction 695 via minimizing the second loss function 675.

The method applies two distinct forms of consistency regularization: one targeting subject images 605 and the other addressing prior images 660. Beginning with the subject images, their latent encodings 610 are first modulated by applying multiplicative noise 615. This step introduces controlled variability to the latent code 612, simulating natural changes such as lighting, texture, or pose. At the same processing step, identical diffusion noise 625 and ground truth noise 620 are added to both the clean and noise-modulated latent codes. These operations yield noisy modulations 630 and 635, which are subsequently processed by the fine-tuned stable diffusion model 640.

The fine-tuned latent stable diffusion model 640 operates with two primary objectives. The first is to generate diffusion noise 645 that closely approximates the ground truth noise 620. This fidelity-focused objective underpins the minimized first loss term, Ls, 655. The second objective ensures that the noise predictions 650 remain consistent with the variations introduced by the multiplicative noise 615. This consistency requirement is enforced through the minimized third loss function, Lcs 658.

Simultaneously, the method processes prior images 660. These images are encoded into latent representations 670 and subsequently diffused 625 to create perturbed latent codes 680. The diffused codes are processed through both the fine-tuned diffusion model 640 and the pre-trained diffusion model 685. The method enforces alignment between the fine-tuned model's predictions 690 and the pre-trained model's predictions 695. This alignment is achieved by minimizing the second loss function, Lcp, 675.

By combining these two pathways—one for subject images and one for prior images—the method ensures the fine-tuned diffusion model generalizes effectively across natural variations while maintaining the integrity of the subject's identity. The structured process depicted in FIG. 6 highlights the robustness of this approach, balancing the need for diversity with fidelity in subject-driven image synthesis.

In some embodiments, the quality of synthesized images is evaluated using one or more evaluation metrics including but not limited to CLIP (Contrastive Language-Image Pretraining) scores and DINO (Distillation with No Labels) scores to determine the effectiveness of the fine-tuned model. CLIP scores evaluate the semantic quality of the synthesized image by comparing how well the synthesized image matches a given textual description or prompt. DINO score provides a measure of how well the features of the synthesized image match those of high-quality, natural images based on the learned representation. By comparing the representation of a generated image to that of real-world images or reference datasets, DINO scores evaluate how realistic or coherent the image is in terms of visual structure. Accordingly, a higher DINO score implies the image exhibits visual patterns that are realistic or coherent in the context of the model's training.

Stable Diffusion Model is a large text-to-image model pretrained on large-scale text-image pairs {(p, x)}, where p is the text prompt of the image x. In Stable Diffusion, we have an auto-encoder E(⋅) and (⋅), a CLIP text encoder τ(⋅), and a UNet based conditional diffusion model f(⋅). The encoder E is used to transform the input image x into the latent space z=E(x), and the decoder D is used to reconstruct the input image from the latent z. The diffusion denoising process of Stable Diffusion is conducted in the latent space. With a randomly sampled noise ε~N(0, I) and at the time step t, we, in embodiments, get a noisy latent code zₜ=αₜz+βₜε, where αₜ and βₜ are the coefficients that control the denoising schedule. Then, the conditional diffusion model f are trained with the following objective for denoising:

$${min}_{p , z , ε , t} [ {‖ ε - f ( {z}_{t} , t , τ ( p ) ) ‖}_{2}^{2} ] \qquad ( 1 )$$

The goal of the conditional model f is to predict the noise by taking the noisy latent zₜ, the text conditional embedding obtained by τ(p), and the time step t as input.

Subject-Driven/specific text-to-image generation finetuning. Let s be a subject in a given set of subject images

$$S = {\{ {x}_{i} \}}_{i = 1}^{K} ,$$

where K is very small. In subject-driven synthesis, a specific text description pₛ, “a photo of S* dog”, is provided towards fine-tuning the diffusion model for the subject s with the following objective:

$${L}_{s} = {{min}_{Δθ}}_{x ∼ S , z = E ( x ) , ε , t} [ {‖ ε - f ( {z}_{t} , t , τ ( {p}_{s} ) ) ‖}_{2}^{2} ] , \qquad ( 2 )$$

where Δθ represents the weights of LoRA module incorporated into Stable Diffusion for fine-tuning that needs to be trained. A naïve fine-tuning scheme as above adapts the learned LoRA weights to shadow the pretrained diffusion weights, thereby forgetting the prior learned knowledge. To alleviate this issue, previous works generate a set of class images

$$P = {\{ {x}_{i} \}}_{i = 1}^{{K}_{p}}$$

where Kₚ, e.g., 100-200 is the number of class images as prior using prompt pp like “a photo of dog”. Fine-tuning the Stable Diffusion model then optimizes objective:

$$L = {L}_{s} + {λ}_{p} {{min}_{Δ θ}}_{x ∼ P , z = E ( x ) , ε , t} [ {‖ ε - f ( {z}_{t} , t , τ ( {p}_{p} ) ‖}_{2}^{2} ] , \qquad ( 3 )$$

where λₚ is a suitable regularization constant.

Preserving identity of subject. Some methods, in order to fit the subject identity and prevent knowledge forgetting, the Δθ need to fit the semantics of both the subject and prior images. However, this is criteria that may be difficult to balance. Instead, some embodiments are based on an insight that is it possible to keep the fine-tuned model to be consistent to pre-trained model for prior images x~P, using following equation to allow the Δθ fit the subject identity, while reduce the effect of the LoRA weights in impacting the pretrained model weights by enforcing consistency between fine-tuned model and pre-trained model for prior images as:

$${L}_{cp} := {E}_{x ∼ P , z = E ( x ) , ε , t} [ {‖ f ( {z}_{t} , t , τ ( {p}_{p} ) - {f}_{ϕ} ( {z}_{t} , t , τ ( {p}_{p} ) ) ‖}_{2}^{2} ] \qquad ( 4 )$$

where f_{φ} is the pre-trained conditional latent stable diffusion model. Ideally, if the fine-tuned model is consistent to the pre-trained model for prior images, then it do not need to fit the prior images, allowing more capacity to fit the subject images to preserve the identity.

Improving diversity. Despite the above solution, some embodiments find the diversity of synthesized images may not be of sufficient diversity due to the only small number of subject images that is typically used. To improve the diversity, we propose to add multiplicative noise to the latent space of the subject image as z′=z⊙εₘ, where εₘ~N(1,σ²I) and σ² is the variance of the multiplicative noise, this could help to expand the latent space of the subject image to improve diversity. Next, we enforce a consistency between the clean latent code z and the noised latent code z′ for the subject images as

$${L}_{cs} := {E}_{x ∼ S , z = E ( x ) , z ′ , ε , t} [ {‖ f ( {z}_{t} , t , τ ( {p}_{s} ) - f ( {z}_{t}^{′} , t , τ ( {p}_{s} ) ) ‖}_{2}^{2} ] .$$

Note that zₜ=αₜz+βₜε and z′t=αₜ(z⊙ₘ)+βₜε share the same diffusion noise.

With these regularization losses, the final objective for the robust subject-driven/specific fine-tuning of one embodiment is:

$$L = {L}_{s} + {λ}_{cp} {L}_{cp} + {λ}_{cs} {L}_{cs} \qquad ( 6 )$$

The Δ_{cs} and/or Δ_{cp} represent hyperparameter with which the third loss function Lcs is scaled to balance diversity and/or identity preservation.

### Exemplar Solutions

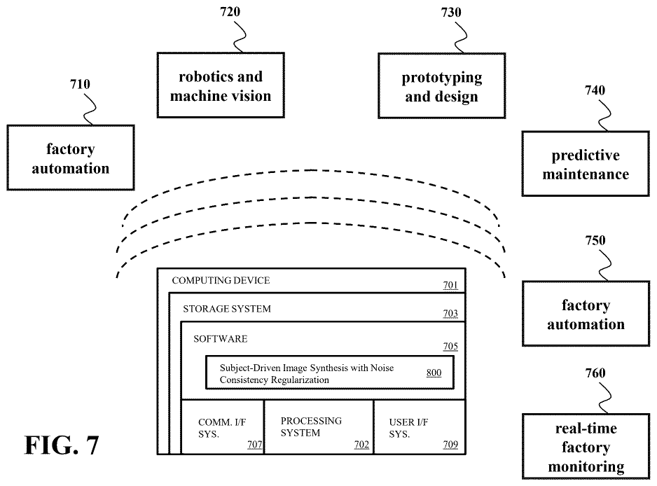

FIG. 7 shows a schematic of computing device 701 that is representative of any system or collection of systems in which the various processes, programs, services, and scenarios of some embodiments disclosed herein are implemented. Examples of computing device 701 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes and implements principles of subject-driven image synthesis with noise consistency regularization (145) described in various exemplar embodiments. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, digital signal processors, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (Subject-Specific Image Synthesis with Noise Consistency Regularization 800 as described with the help of the system 100, the method 600, or any other method described in the present disclosure) may be implemented in program instructions and among other functions may, when executed by processing system 702, direct processing system 702 to operate as described with respect to the various operational scenarios, sequences, frameworks, and processes illustrated and/or discussed herein. For example, software 705 may include program instructions for implementing the sampling, training, and/or rendering processes described herein, as well as the probabilistic guided sampling discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to perform computer vision processes in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The computing device shown in FIG. 7 is capable of controlling a variety of exemplar systems by leveraging the principles of subject-driven image synthesis with noise consistency regularization. Exemplar systems, in embodiments, that are effectively controlled by the computing device 701, include factory automation 710, robotics and machine vision 720, prototyping and design 730, predictive maintenance 740, factory automation 750, and real-time factory monitoring 760.

### Application to Visual Inspection and Quality Control in Factory Automation

Subject-driven image synthesis offers transformative potential for visual inspection and quality control in factory automation 710 by enabling the generation of diverse and contextually meaningful representations of components. These synthetic images, in embodiments, simulate various operational conditions, helping machine vision systems detect defects with higher accuracy and robustness. The method outlined in the claim leverages advanced techniques like Noise Consistency Regularization to achieve these goals.

The process begins by collecting high-quality images of the components to be inspected. These images, known as subject images, represent the standard or defect-free state of the components. Encoding these subject images into latent representations captures their critical features, such as geometry, texture, and color. These latent representations serve as the foundation for generating diverse variations that mimic real-world conditions.

Noise Consistency Regularization plays a pivotal role in this application by ensuring that the synthesized images maintain fidelity to the original components while introducing meaningful variability. This technique involves applying controlled perturbations, such as multiplicative Gaussian noise, to the latent representations of the subject images. These perturbations simulate natural variations, such as changes in lighting, viewing angles, or surface conditions. The regularization process aligns the noise predictions of the fine-tuned diffusion model with the ground truth, ensuring that these perturbations are treated as valid variations rather than distortions.

By generating diverse representations of components under various operational conditions, the method creates a comprehensive dataset for training machine vision systems. For instance, the synthesis process, in embodiments, simulates defects like scratches, dents, or alignment issues that may not frequently occur in real-world data but are critical for robust defect detection. These synthesized defect scenarios expand the range of the training dataset, making it more representative of potential real-world conditions.

The fine-tuned diffusion model's ability to enforce consistency between perturbed and original representations ensures that even rare or extreme defect conditions are accurately captured. The consistency loss terms, such as Ls and Lcs, optimize the model to generate outputs that are both diverse and faithful to the subject's identity. This guarantees that the synthesized images not only introduce variations but also retain the core attributes of the components, such as shape and structural integrity, which are essential for reliable defect detection.

With a diverse and high-quality synthetic dataset, machine learning models, such as convolutional neural networks (CNNs), in embodiments, are trained to detect defects more effectively. These models benefit from the enriched dataset by learning to identify subtle deviations that may indicate defects. Furthermore, the incorporation of Noise Consistency Regularization ensures that the dataset remains balanced, avoiding overfitting to specific variations while maintaining a broad generalization capability.

Once trained, the machine vision systems are ready to be deployed in the factory's quality control pipeline. These systems, in embodiments, inspect components in real time, identifying defects with precision. The robustness of the defect detection is enhanced by the diversity of the training data, which accounts for a wide range of operational conditions and potential defects. Moreover, as new defect types or variations emerge, the synthesis process, in embodiments, is further used to generate additional data for retraining and improving the system.

In summary, the integration of subject-driven image synthesis with Noise Consistency Regularization addresses key challenges in visual inspection and quality control, such as data scarcity and variability. By generating diverse, high-fidelity representations of components, the method improves the accuracy and robustness of defect detection systems. This approach ensures that factory automation processes become more reliable, efficient, and adaptable to changing manufacturing conditions.

### Application to Robotics and Machine Vision

In some embodiments, the subject-driven image synthesis is applied in robotics and machine vision 720 to enhance the adaptability and performance of robotic systems in dynamic factory environments. This approach leverages fine-tuned diffusion models to generate synthetic images that capture a wide range of scenarios, allowing robotic systems to improve object recognition and manipulation capabilities. By utilizing advanced methods like Noise Consistency Regularization, this technique supports the development of versatile robotic solutions tailored to evolving factory setups.

The process begins by acquiring high-quality images of tools, components, and factory environments that represent the operational domain of the robotic systems. These images are used as inputs to the fine-tuned diffusion model, which encodes them into latent representations. These representations distill the essential features of the tools and environments, including shapes, textures, and spatial relationships. By using subject-driven image synthesis, the model generates diverse synthetic images, introducing variations in lighting, angles, and occlusions to reflect realistic factory scenarios.

The diffused model's ability to incorporate controlled perturbations and maintain consistency through Noise Consistency Regularization ensures that the synthetic images remain both diverse and accurate. Perturbations such as multiplicative Gaussian noise are applied to the latent representations to simulate changes in factory setups, like altered tool placements, new components, or varying environmental conditions. The consistency loss functions ensure that the synthetic images align with the features of the original images, preserving essential characteristics while allowing for dynamic variations.

These synthetic images, in embodiments, are used to train robotic systems for tasks such as object recognition and manipulation. For example, the diverse dataset generated by the synthesis process enables robots to identify tools or components from multiple angles and under different lighting conditions. This reduces the need for extensive real-world data collection, which are, typically, time-consuming and expensive, especially in factories with modular production lines or frequently changing configurations.

By training on these synthetic datasets, robotic systems are adapted for dynamic factory setups without requiring significant reprogramming. For instance, in a modular production line where tools and components may be rearranged regularly, the system, in embodiments, relies on its training with diverse synthetic images to recognize objects in new positions or under new configurations. This adaptability enhances operational efficiency, as robots are configured to perform tasks with minimal human intervention and reduced downtime for reprogramming.

The diffusion model also aids in simulating factory environments to help robots navigate and interact within the workspace. Synthetic images of the factory layout, including pathways, obstacles, and zones of operation, in embodiments, are used to train robots to navigate effectively and avoid collisions. This capability is particularly beneficial in environments where layouts change frequently, as the system is configured to generalize its navigation strategies without needing constant retraining.

Overall, subject-driven image synthesis using fine-tuned diffusion models offers a practical way to support robotics and machine vision in factory automation. By generating diverse synthetic datasets and leveraging the strengths of Noise Consistency Regularization, this approach enhances the adaptability and robustness of robotic systems. It allows them to operate effectively in dynamic and modular factory setups, reducing the reliance on extensive reprogramming and facilitating seamless transitions between changing production environments.

### Application to Prototyping and Design

In some embodiments, the subject-driven image synthesis offers a practical approach to product prototyping and factory design by enabling the rapid generation of diverse visual prototypes and tailored factory layouts/designs 730. Using fine-tuned diffusion models, the method begins with high-quality images of machinery, components, or layouts, encoding their features into latent representations. These representations are then used to create synthetic prototypes with controlled variations in design configurations, such as size, shape, or material, allowing for efficient exploration of alternatives without physical prototyping.

Noise Consistency Regularization ensures the generated prototypes remain true to the original designs while introducing meaningful diversity. This capability supports rapid evaluation and iteration of design ideas, helping stakeholders compare multiple configurations and gather feedback. For factory setups, the method generates realistic visualizations of workflows, machinery placement, and production processes, allowing teams to optimize layouts and adapt to changing production needs.

By enabling iterative design and customization through high-fidelity synthetic visualizations, this approach accelerates the prototyping process, reduces costs, and enhances collaborative decision-making. It also supports virtual simulations of workflows to test and refine operations, making it a valuable tool for modern product and factory design processes.

### Application to Predictive Maintenance

Subject-driven image synthesis provides a valuable tool for predictive maintenance 740 by enabling the generation of diverse visual representations of machinery operating under various conditions. Using fine-tuned diffusion models, this method creates synthetic images that capture both normal operating states and early indicators of wear or failure, offering maintenance systems a rich dataset for analysis and training.

The process starts with high-quality images of machinery in its optimal condition. These images are encoded into latent representations that preserve the essential features of the equipment, such as structural elements, textures, and operational characteristics. Controlled perturbations, guided by Noise Consistency Regularization, are then applied to these latent representations to simulate gradual wear, operational variations, and the onset of potential failure modes. This ensures that the generated images remain realistic while introducing meaningful diversity to reflect different operating states.

In addition to representing common operational conditions, the method is particularly effective in simulating rare or extreme failure scenarios. For instance, synthetic images, in embodiments, depict machinery operating under stress conditions that typically lead to uncommon but critical failures, such as overheating, misalignment, or excessive vibration. These scenarios are often difficult to capture in real-world data but are essential for training robust predictive maintenance systems.

In some embodiments, the synthetic imagery generated through this approach is used to train machine learning models for proactive maintenance. By incorporating diverse examples of both normal operations and potential issues, these models learn to recognize subtle changes in machinery behavior that may indicate early signs of failure. This capability enables maintenance systems to identify and address problems before they escalate, reducing downtime and repair costs.

Moreover, the ability to simulate rare failure scenarios enhances the robustness of maintenance systems. Training on these synthetic datasets allows the models to generalize across a wide range of conditions, improving their ability to detect and respond to unexpected issues. Maintenance teams, in some embodiments, also use these visualizations to develop and refine response protocols, ensuring quick and effective resolution of problems.

In effect, subject-driven image synthesis, combined with fine-tuned diffusion models and Noise Consistency Regularization, offers a practical and efficient approach to predictive maintenance. By generating diverse, high-fidelity imagery of machinery under varying conditions, this method supports the development of advanced maintenance systems capable of proactive issue detection and resolution. This not only improves operational efficiency but also extends the lifespan of machinery by enabling timely interventions.

### Application to Factory Automation

Subject-driven image synthesis provides a practical solution for creating training and simulation environments in factory automation 750 by generating high-fidelity virtual factory models. By leveraging fine-tuned diffusion models, this method produces detailed images of machinery, workflows, and production lines, enabling comprehensive operator training and workflow simulations. This approach helps factories achieve greater efficiency and adaptability in their operations.

The process begins with high-quality images of real factory machinery and layouts, which are encoded into latent representations that capture their structural and operational details. Using these representations, the fine-tuned diffusion model generates realistic and detailed virtual images of factory environments. These synthetic images, in embodiments, depict machinery from different angles, under varied conditions, and in diverse configurations, ensuring that operators gain an in-depth understanding of the systems they work with.

Virtual factory models created through this method are ideal for operator training programs. They allow operators to interact with simulated environments that closely resemble real-world conditions, including complex machinery setups and dynamic workflows. Training scenarios, in some embodiments, include step-by-step visual instructions, troubleshooting exercises, and safety drills, all supported by the high fidelity of the synthetic imagery. This immersive approach helps operators build confidence and competence before working on the actual factory floor.

In addition to training, the method enables the creation of digital twins-virtual replicas of factory environments that simulate complex workflows and production processes. By using subject-driven image synthesis, digital twins, in embodiments, incorporate detailed visualizations of machinery and production lines, along with dynamic elements like material flow and worker movements. These simulations allow factory managers to evaluate workflow efficiency, identify bottlenecks, and test potential process optimizations in a risk-free virtual environment.

Digital twins also support continuous improvement by enabling iterative testing and refinement of production processes. For instance, managers, in embodiments, simulate the impact of changes in factory layouts, machinery configurations, or production schedules without disrupting actual operations. The flexibility and detail provided by subject-driven image synthesis ensure that these simulations offer actionable insights to enhance productivity and reduce downtime.

In effect, subject-driven image synthesis enhances factory training and simulation environments by creating realistic, detailed virtual models of machinery and workflows. These high-fidelity models not only improve operator training but also facilitate the simulation and optimization of production processes through digital twins. This approach provides a cost-effective and scalable way to support continuous improvement in factory automation.

### Application to Real-Time Factory Monitoring

Subject-driven image synthesis plays an important role in enhancing real-time factory monitoring systems 760 by integrating synthesized images for improved visualization and anomaly detection. Using fine-tuned diffusion models, this approach creates diverse, high-fidelity representations of machinery in both normal and faulty states, enabling more accurate and efficient monitoring of factory operations.

The process begins by collecting images of machinery under standard operating conditions, which are encoded into latent representations that capture the machinery's critical features. These representations are used by the diffusion model to generate synthetic images that simulate a range of operational states, including normal conditions and various failure scenarios. The ability to produce diverse synthetic representations ensures that monitoring systems is adapted to compare real-time data against a comprehensive baseline of expected states.

These synthetic images are integrated into factory monitoring systems to provide real-time visualization of machinery status. By displaying the synthetic images alongside live data, operators gain a clearer understanding of how current machinery states align with normal operating conditions or deviate into potential faults. This real-time integration improves situational awareness, helping operators make faster, more informed decisions when anomalies arise.

Anomaly detection is enhanced through the comparison of real-time sensor or image data with synthetic representations. For example, if a machine begins to exhibit unusual behavior, such as unexpected vibrations, temperature fluctuations, or misaligned components, the system is arranged to identify discrepancies by referencing the synthetic images of both normal and faulty states. This enables the early detection of potential issues, allowing maintenance teams to address problems proactively before they escalate.

The use of diverse synthetic imagery also improves the robustness of machine learning models used in anomaly detection. By training these models with synthetic data that includes a wide range of operational scenarios, these models are configured to better recognize subtle deviations from normal behavior, even in complex or rare conditions. This reduces false positives and enhances the overall accuracy of anomaly detection systems.

In effect, subject-driven image synthesis enhances real-time factory monitoring by integrating detailed synthetic images into visualization systems and supporting anomaly detection. This approach provides operators with a clear understanding of machinery states and equips monitoring systems with the ability to proactively identify and address potential issues. The result is improved operational efficiency, reduced downtime, and a more responsive manufacturing environment.

As will be appreciated by one skilled in the art, aspects of the present disclosure may be embodied as a system, method or computer program product. Hence, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

1. A computer-implemented method for fine-tuning a pre-trained diffusion-based generative model to synthesize subject-specific images, comprising:
obtaining a pre-trained diffusion model, a set of subject images, and a set of prior images generated by the pre-trained diffusion model;
fine-tuning the pre-trained diffusion model by optimizing a first loss function (Ls) configured to predict diffusion noise for the subject images during a reverse diffusion process to preserve an identity of a subject in the subject images subject to a noise consistency regularization that optimizes a second loss function (Lcp) to minimize a discrepancy between prediction of the diffusion noise of the pre-trained and fine-tuned diffusion models for the prior images; and
outputting a fine-tuned diffusion model configured to generate subject-specific images while retaining generalization capabilities of the pre-trained diffusion model.

2. The method of claim 1, wherein computing the second loss function comprises:
generating a latent representation of the prior images;
processing the latent representation through both the pre-trained diffusion model and the fine-tuned diffusion model; and
computing the second loss function Lcp to minimize the discrepancy between the noise predictions of the pre-trained and fine-tuned diffusion models for each of the prior images.

3. The method of claim 1, further comprising:
applying multiplicative Gaussian noise to latent representations of the subject images to create perturbed latent representations;
processing both original and perturbed latent representations through the fine-tuned diffusion model; and
optimizing a third loss function Les to minimize the discrepancy between the noise predictions for the original and perturbed latent representations of the subject images, thereby improving diversity in the generated subject-specific images.

4. The method of claim 1, wherein the prior images are selected from a class similar to the subject images.

5. The method of claim 1, wherein the first loss function Lₛ minimizes a difference between a ground-truth noise added during a forward diffusion process and a predicted noise during the reverse diffusion process.

6. The method of claim 3, wherein the multiplicative Gaussian noise applied to the latent representations is defined by ϵₘ~N(1,σ²I), where σ² is a variance parameter.

7. The method of claim 1, wherein the fine-tuned diffusion model is configured to generate images in response to textual prompts describing the subject.

8. The method of claim 1, wherein the fine-tuning is performed using a low-rank adaptation (LoRA) method to update only a subset of parameters of the pre-trained diffusion model or additional parameters added to the pre-trained diffusion model.

9. The method of claim 3, wherein the third loss function Lcs is scaled by a configurable hyperparameter to balance diversity and identity preservation.

10. The method of claim 1, further configured to evaluate the quality of synthesized images using one or more evaluation metrics, including CLIP scores and DINO scores.

11. The method of claim 1, wherein the subject-specific image synthesis is applied to visual inspection and quality control in factory automation, further comprising:
generating diverse representations of components under varying operational conditions to train machine vision systems for defect detection; and
enhancing the accuracy and robustness of defect detection systems by simulating potential variations in component features or manufacturing defects.

12. The method of claim 1, wherein the subject-specific image synthesis is utilized for robotics and machine vision, the method further comprising:
generating synthetic images of tools, components, and factory environments to train robotic systems for object recognition and manipulation; and
allowing robotic systems to adapt to dynamic factory setups and modular production lines without requiring extensive reprogramming.

13. The method of claim 1, wherein the subject-specific image synthesis is applied to product prototyping and design, the method further comprising:
creating diverse visual prototypes of machinery or components to facilitate rapid evaluation and iteration of design configurations; and
customizing factory layouts and setups by generating tailored visualizations of workflows and production processes.

14. The method of claim 1, wherein the subject-specific image synthesis is applied to predictive maintenance, the method further comprising:
generating imagery of machinery operating under different conditions, including normal states and early signs of wear or failure; and
simulating rare failure scenarios to train maintenance systems for proactive identification and resolution of potential issues.

15. The method of claim 1, wherein the subject-specific image synthesis is applied to training and simulation environments in factory automation, the method further comprising:
creating high-fidelity virtual factory models with detailed images of machinery, workflows, and production lines for operator training; and
enabling the simulation of complex workflows through digital twins to optimize production processes and support continuous improvement.

16. The method of claim 1, wherein the subject-specific image synthesis supports real-time factory monitoring, the method further comprising:
integrating synthesized images into monitoring systems to provide real-time visualization of machinery states; and
enabling anomaly detection through comparison of real-time data with diverse synthetic representations of normal and faulty operating conditions.

17. A system for fine-tuning a diffusion-based generative model to synthesize subject-specific images, comprising: a memory for storing instructions; and a processor configured to execute the instructions to:
obtain a pre-trained diffusion model, a set of subject images and a set of prior images;
fine-tune the pre-trained diffusion model by
optimizing a first loss function Ls to predict diffusion noise for the subject images during reverse diffusion, and preserving a subject's identity;
optimizing a second loss function Lcp to enforce consistency between the noise predictions of the pre-trained and fine-tuned diffusion models for the prior images; and
optimizing a third loss function Lcs to enforce consistency between noise predictions for original and perturbed latent representations of the subject images; and
output a fine-tuned diffusion model configured to generate subject-specific images with improved fidelity and diversity.

18. A non-transitory computer-readable storage medium embodied thereon a program executable by a processor for performing a method for fine-tuning a pre-trained diffusion-based generative model to synthesize subject-specific images, the method comprising:
obtaining a pre-trained diffusion model, a set of subject images, and a set of prior images generated by the pre-trained diffusion model;
fine-tuning the pre-trained diffusion model by optimizing a first loss function (Ls) configured to predict diffusion noise for the subject images during a reverse diffusion process to preserve an identity of a subject in the subject images subject to a noise consistency regularization that optimizes a second loss function (Lcp) to minimize a discrepancy between prediction of the diffusion noise of the pre-trained and fine-tuned diffusion models for the prior images; and
outputting a fine-tuned diffusion model configured to generate subject-specific images while retaining generalization capabilities of the pre-trained diffusion model.
